(19) United States
(12) Patent Application Publication
(10) Pub. No.: US 2005/0025901 A1
(43) Pub. Date: Feb. 3, 2005

(54) Method of curing coatings on automotive bodies using high energy electron beam or X-ray

(76) Inventors: David R. Kerluke, Orleans (CA); Richard Galloway, East Islip, NY (US); Marshall R. Cleland, Hauppauge, NY (US); Victor J. Balmer, Lake San Marcos, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 10/630,785

(22) Filed: Jul. 31, 2003

(51) Int. Cl. B05D 3/00

(52) U.S. Cl. 427/496; 427/532

(57) ABSTRACT

The invention is directed to the use of medium to high power (greater than or equal to 1 kW) and medium to high energy (greater than or equal to 1 MeV) electron beam or X-ray to cure coatings in thick complex three dimensional automotive bodies. The medium to high power, medium to high energy has sufficient throughput and penetration to permit curing through multiple layers of steel and, therefore, is able to penetrate shadows caused by the bends, folds and curves in automotive bodies. In addition, the medium to high power, medium to high energy beam has sufficient throughput and penetration to cure the thicker coatings that accumulate in surface cracks and crevices. The invention permits the use of electron beam curable coatings and, thereby, reduces the fire hazard, hazardous air pollutant, and volatile organic problems associated with the non-reactive solvents used in the solvent based paints conventionally employed in the automotive industry.

### 1.0 FIELD OF THE INVENTION

The invention is directed to the use of medium to high power, medium to high energy electron beam or X-ray to cure coatings. More specifically, the invention is directed to the use of medium to high power, medium to high energy electron beam or X-ray to cure coatings on relatively thick complex three dimensional objects such as automotive bodies.

### 2.0 BACKGROUND OF THE INVENTION

The major components of coatings are solvents, binders and, optionally, pigments, additives and extenders. Solvents are added to disperse the other constituents and reduce the viscosity to ensure easy, smooth and homogeneous application. In the past, as much as 70% of coatings were made up of solvents. The most widely used organic solvents are toluene, xylene, methyl ethyl ketone and methyl isobutyl ketone.

The use of solvents in coatings has been a major environmental concern. Organic solvents volatilize at normal temperature and pressure. Therefore, solvent vapors are released during routine paint application (e.g., when paints are atomized by a sprayer), during curing and during cleanup operations. Solvent vapors are a dangerous fire hazard. In addition, solvent vapors include hazardous air pollutants (HAPs) which are a significant health risk. Furthermore, solvent vapors include and/or generate volatile organic compounds (VOCs) which react with nitrogen oxides (NOx) in the presence of sunlight to create photochemical ozone or smog.

In 1991, 11% of all VOC emissions were thought to be the result of surface coating operations. See U.S. Environmental Protection Agency, National Air Pollutant Emission Estimates, 1990-1991, October 1992. To address this problem, the 1990 Clean Air Act, which became effective in 1996, requires lower emissions of VOCs. In addition, numerous other federal, state and local regulations limit VOC emissions. Complying with these regulations is a significant cost to paint facilities.

The main function of automotive coatings are to improve appearance, exterior durability, and corrosion protection. Automotive coatings are applied to the steel body, some parts of which may be formed from polymers and/or composite materials, in multiple layers. Currently, the typical practice is to treat the body with zinc phosphate, or a similar corrosion inhibitor, and then provide four additional coatings. First, a water based cathodic electrocoat (e-coat) is applied to the body. Second, a primer surfacer is applied over the electrocoat. Third, a color base coat is applied. Generally this is done using a water-borne paint, but water borne paints still contain solvents. Fourth, and finally, a clear coat is applied using a solvent based medium. The coats are cured by baking cycles in a continuous oven.

Automobile paint facilities in the United States contain an array of abatement equipment to reduce VOCs. The abatement equipment can represent as much as 10% of the total investment in the paint facility. The abatement equipment adds millions of dollars in overhead cost without adding anything of value to the vehicle being produced. Furthermore, the abatement equipment consumes energy and produces nitrogen oxides (NOx) which, while not prohibited, are not beneficial. Through these and other measures, auto companies have reduced emissions in their painting operations about 80% since the 1960s. But the low hanging fruit has been picked and further VOC reduction, while necessary, will be more difficult.

Radiation curable coatings are known. Ultraviolet (UV) and low energy electron beam technologies have been used for many years to cure thin paints and coatings on small industrial and commercial products, including beverage cans, magazines, and lottery tickets. In general, radiation curing initiates free radical or cationic polymerization in specially formulated coatings directly on the substrate. Non-reactive solvents are not necessary in radiation curable coatings so the coatings can be 100% reactive liquids. Some radiation curable coatings volatilize, resulting in limited VOC emissions, but such emissions are comparatively low and often non-existent.

Electron beam curable coatings are cured by bombarding the coatings with electrons. In contrast to UV curable coatings, electron beam curable coatings do not require photoinitiators because the electron bombardment itself provides sufficient energy to generate free radicals. In addition, electron beam curing is not affected by opacity or pigmentation.

Unfortunately, electron beam curing has been limited to curing thin coatings on relatively flat surfaces. This is due to the nature of the electron beam accelerators previously available, which were either low power or low energy accelerators. Low power accelerators (i.e., less than 1 kW) are not very useful because low power means limited throughput rate. Other factors being equal, a 200 kW accelerator processes four times as much material as a 50 kW accelerator per unit time. Low energy accelerators (e.g., 50 to 300 keV) are restricted in application because low energy means low electron penetration. Although exact penetration will vary with density, this generally correlates to less than 0.5 millimeters at 300 keV or about 3 to 4 millimeters of plastic material penetration per MeV. (Note that electron penetration is not directly proportional to electron beam energy at low energies because of the energy loss in the beam window of the accelerator.) Such penetration is only suitable for line of sight curing of very thin films. The electrons do not have sufficient energy to penetrate through multiple layers of steel plate to reach surfaces hidden by bends, curves and folds in the product. The electrons do not have sufficient energy to penetrate into the thicker areas of film that form in cracks and crevices. Thus, conventional electron beams have not been used to cure films on automotive bodies which have large complex three dimensional steel surfaces of varying thickness.

Advanced Electron Beams Inc. (AEB) recently suggested that its low energy electron beam device might allow the auto industry to replace conventional paint lines. See Electron Beams For Everyone, BusinessWeek, pp. 95-96, May 26, 2003. However, the AEB device, while relatively small (80 to 120 keV and possibly lower), suffers from the same low energy drawbacks as prior devices. Thus, it is only capable of line of sight curing.

The concept of processing products with X-rays generated by bombarding high density targets with high-energy electrons was proposed over 25 years ago. X-rays exhibit much greater material penetration than electrons. However, this concept has received little attention commercially because of relatively high electron beam power requirements to produce reasonable x-ray power. The process of converting electrons into X-rays is very inefficient (e.g., 15% or less for electron beam energies less than 10 MeV).

In the mid 1990's, Ion Beam Applications, S.A. (IBA) introduced a family of revolutionary medium to high power, medium to high energy electron beam accelerators. The Rhodotron® TT 100 generates up to 35 kW at 10 MeV (3.5 mA). The Rhodotron® TT 200 generates up to 100 kW at 10 MeV (10 mA) and up to 100 kW at 5 MeV (20 mA). The Rhodotron® TT 300 generates up to 200 kW at 10 MeV (20 mA) and up to 135 kW at 5 MeV (27 mA). The beam powers for the Rhodotron® TT 200 and TT 300 are guaranteed to 80 kW and 150 kW, respectively, for continuous industrial service. IBA has built, and is in the final stages of testing, the world's first very high power industrial accelerator, the Rhodotron®TT 1000, rated at 7 MeV and 700 kW. The Rhodotron® family of accelerators are described in U.S. Pat. No. 5,107,221, the entirety of which is incorporated herein by reference.

### 3.0 SUMMARY OF THE INVENTION

The newest generation of medium to high power, medium to high energy electron beams, such as those produced by IBA, have sufficient throughput and penetration to cure coatings on large thick objects with complex three dimensional surfaces, such as automotive bodies. Accordingly, one aspect of the invention is a method for curing one or more coatings on an automotive body comprising: (i) coating the automotive body with at least one electron beam curable coating; and (ii) passing the automotive body one or more times through one or more medium to high power, medium to high energy electron beams.

IBA's medium to high power, medium to high energy accelerators, especially the newest TT 1000 accelerator (rated at 7 MeV and 700 kW), make the generation of large quantities of X-rays a viable alternative for curing coatings on automotive bodies. X-rays penetrate film thicknesses that are about an order of magnitude deeper than electrons. Accordingly, another aspect of this invention is a method for curing one or more coatings on an automotive body comprising: (i) coating the automotive body with at least one X-ray curable coating; and (ii) passing the automotive body through one or more X-ray fields generated by striking a metal target with a medium to high power, medium to high energy electron beam.

The present invention employs medium to high power, medium to high energy electron beams. The electron beams employed in the invention typically have energies of at least 1 MeV, preferably at least 3 MeV, more preferably at least 5 MeV and as high as 10 or 12 MeV. This is much higher than the conventional low energy beams used in the coating arts which typically have beam energies in the 50 to 300 keV range. The electron beams employed in the invention typically have power capabilities of at least 1 kW, preferably at least 10 kW, more preferably at least 35 kW, even more preferably at least 80 kW, ideally at least 150 kW and, in at least in one embodiment, as high as 200 kW to 700 kW.

The methods of the instant invention provide a number of benefits. First, electron beam and X-ray enable the elimination or reduction of non-reactive solvent use in the automobile coating industry. Second, electron beam and X-ray provide extremely rapid curing—potentially less than a minute per car body—as well as instantaneous startup and shutdown capabilities. Third, electron beam and X-ray curing are low temperature processes. Fourth, radiation curable coatings as a class, tend to have a longer shelf life and a longer pot life because the coatings are single component systems. Fifth, in this same vein, radiation curable coatings tend to exhibit better hardness, solvent resistance, stain resistance and abrasion resistance. The lower volatile content in radiation curable coatings also gives them higher gloss, better build, and lower shrinkage. Sixth, electron beam accelerators are more energy efficient compared to thermal ovens. Seventh, electron beam accelerators require less floor space than conventional thermal ovens and the capital cost for electron beam curing facilities is comparable to oven curing facilities.

Although the invention is described largely in the context of curing coatings on automotive bodies it is not so restricted since similar problems are encountered when coating other large three dimensional objects which are solved by the invention. Accordingly, another aspect of the invention is a method for curing one or more coatings on an object made from a sheet material that is curved, bent or folded into a three dimensional structure comprising: (i) coating the object with at least one electron or X-ray curable coating; and (ii) moving the object one or more times through one or more medium to high power, medium to high energy electron beams or X-ray fields, whereby at least one electron beam and/or X-ray field is capable of penetrating through multiple layers of said sheet material to cure areas of coating not in the visible line of sight of said beam or field. In one embodiment, the sheet material has an equivalent area density (i.e., thickness multiplied by volume density) that is equal to or greater than the equivalent area density of 3 mm of plastic material. In another embodiment, the sheet material has an equivalent area density that is equal to or greater than the equivalent area density of 0.4 mm of steel.

Another aspect of the invention is a facility that performs any one of the methods described above. Accordingly, the invention includes a plant that comprises the following components: (i) one or more objects made from a sheet material that is curved, bent or folded into a three dimensional structure and coated with one or more electron beam or X-ray curable coatings; (ii) a conveyor system for moving said one or more objects past an electron beam and/or X-ray field; and (iii) one or more accelerators capable of generating one or more medium to high power, medium to high energy electron beams and/or X-ray fields capable of penetrating through multiple layers of said sheet material to cure areas of coating not in the line of sight of said beam(s) or field(s).

Other aspects of the invention will be apparent to those of ordinary skill in the art in view of the disclosure provided herein.

### 4.0 BRIEF DESCRIPTION OF THE DRAWINGS

FIG. 1A is an overhead schematic of a vertical maze that can be used in the invention.

FIG. 1B is a side schematic of a vertical maze that can be used in the invention.

FIG. 2A is an overhead schematic of a vertical and horizontal maze that can be used in the invention.

FIG. 2B is a side schematic of a vertical and horizontal maze that can be used in the invention.

FIG. 3A is an overhead schematic of a horizontal maze that can be used in the invention.

FIG. 3B is a side schematic of a horizontal maze that can be used in the invention.

FIG. 4 is a graph showing thee 5 MeV electron energy deposition in iron coated with a 50 micron acrylic coating.

FIG. 5 is a graph showing the 7 MeV electron energy deposition in iron-coated with a 50 micron acrylic coating.

FIG. 6 is a graph showing the 10 MeV electron energy deposition in iron coated with a 50 micron acrylic coating.

FIG. 7 is a graph showing the 5 MeV X-Ray energy deposition in iron using a 1.2 mm tantalum target

FIG. 8 is a graph showing the 6 MeV X-Ray energy deposition in iron using a 1.2 mm tantalum target

FIG. 9 is a graph showing the 7 MeV X-Ray energy deposition in iron using a 1.2 mm tantalum target

FIG. 10 is a graph showing the 7 MeV X-Ray energy deposition in iron using a 1.4 mm tantalum target

FIG. 11 is a graph showing the 7 MeV X-Ray energy deposition in iron coated with a 50 micron acrylic coating.

FIG. 12 is an illustration of a steel plate stack and shows the expanded corner of steel plate therein.

### 5.0 DETAILED DESCRIPTION OF THE PREFERRED EMBODIMENTS

5.1 Definitions

As used herein, the following terms are intended to have the following meanings:

“Low energy” means less than 1 MeV, typically 100 to 300 keV.

“Medium energy” means at least 1 MeV but less than 5 MeV.

“High energy” means 5 MeV or higher.

“Medium to high energy” means at least 1 MeV.

“Low power” means less than 1 kW.

“Medium power” means at least 1 kW but less than 80 kW.

“High power” means greater than or equal to 80 kW.

“Medium to high power” means at least 1 kW.

“Auto body,” “automobile body,” “automotive body, “vehicle body” and “car body” as used interchangeably herein refer to the main portion of a car, truck, bus, motorcycle, tractor or any other automotive transportation vehicle, including at least the frame or shell, but optionally including other parts such as doors, hood, trunk, axles, etc. Auto bodies are typically made of steel but other materials, including aluminum, polymers (plastics and rubbers), fiber glass, carbon fiber, composites and even wood can be used interchangeably or in combination with steel.

“Shadows” and “Shadowing” as used herein refers to areas on a product's surface that are not visible along a given line of sight due to curves, bends and folds on the product's surface.

“Coating” as used herein refers to one or more covering layers spread over the surface of an object usually for the purpose of protection and/or decoration. Paints are one type of coating.

“Paint” refers to coatings that are added, at least in part, to convey color.

“Line of sight” refers to the ability to see a given area from a given orientation. The given orientation, in the context of curing coatings with electron beam and or X-ray, is the output point for the electron beam or X-ray field.

“Equivalent area density” refers to the thickness of a material multiplied by its volume density.

5.2 Overview

With the advent of medium to high power, medium to high energy industrial electron accelerators, electron beam technology can now be used to cure paints and coatings on automotive bodies, thereby increasing curing speed, reducing factory floor space, reducing volatile emissions, and reducing energy costs. Electron beam is not only suitable for curing coatings on steel panels, it is also suitable for curing coatings on thermoplastic panels due to the lower temperatures involved during curing. In accordance with the invention, at least one medium to high power, medium to high energy accelerator is used to produce one or more electron beams or X-rays to cure one or more coatings on an automotive body.

Currently, the typical practice in the automotive industry is to treat car bodies with zinc phosphate, or a similar corrosion inhibitor, and then provide four additional coatings. First, a water based cathodic electrocoat (e-coat) is applied to the car body. Second, a primer surfacer is applied over the electrocoat. Third, a color base coat is applied, which is generally waterborne but still contains solvents. Fourth, and finally, a clear coat is applied using a solvent based medium. These coatings are known in the art, well documented, and commercially available from manufactures including BASF and PPG. Specific formulations vary somewhat between automobile manufacturers.

Suitable electrocoats are known in the art and commercially available. Electrocoat (e-coat) refers to an electrodeposition primer. Electrocoats have been known for nearly 40 years and are widely employed to improve the corrosion resistance on industrial metal objects. During electrocoating, electrically charged particles are deposited out of a water suspension to coat a conductive product. The electrocoat is applied to a product at a certain film thickness, which is regulated by the amount of voltage applied. The deposition is self-limiting and slows down as the applied coating electrically insulates the product. Electrocoat solids deposit initially in the areas closest to the counter electrode and, as these areas become insulated to current, solids are forced into more recessed, bare metal areas to provide complete coverage. Typical e-coats are epoxy based aqueous cathodic electrodeposition (CED) primers. The first CED primer was an Epon resin with pendant amine groups cured with blocked isocyanates, e.g., toluene diisocyanate. Today, most CED primers use oxime-blocked toluene diisocyanate as the curing agent. Suitable e-coats are commercially available from companies such as BASF and PPG.

Suitable primers are known in the art and commercially available. The primer is generally applied by spraying. Often, the primer is a powder. The dominant powder primer surfacer is an epoxy-polyester. The primer can also be an electro-coat. For example, PPG sells PowerPrime a two-bath electrocoat system introduced last year at the DaimlerChrysler plant in Brazil. PowerPrime is a two-in-one electrocoat primer where a first bath applies a lead-free corrosion-inhibiting primer and a second bath applies a full body anti-chip primer surfacer. This process saves the step of spray painting on the primer coat.

Suitable color base coats are known in the art and commercially available. Suitable base coats typically contain pigments. The binder in the base coat can be selected from acrylic resins, alkyd resins, polyurethane resins, polyester resins and aminoplast resins. Typical base coats are solvent or waterborne polyester coatings.

Suitable clear coats, or top coats, are known in the art and commercially available from manufactures such as Nippon Paint. Clear coats are utilized to protect the paint job from the elements. Suitable clear coats include acrylic resins, alkyd resins, polyurethane resins, polyester resins and aminoplast resins. Typically, clear coats comprise a solvent born acrylic or urethane. BASF sells Ureclear® clear coat, a one component acrylic with carbamate functionality which provides urethane properties without the use of an isocyanate. BASF has also developed a powder-slurry clear coat for autobodies that is reportedly a zero-VOC product. The BASF powder-slurry has been applied to Mercedes-Benz vehicles and is undergoing trials at the Low Emissions Paint Consortium test facility in Michigan (a joint R&D project being carried out by GM, Ford, and DaimlerChrysler).

A typical basecoat and clearcoat is 20 and 50 μm thick, respectively, with a density of at least 1 g/cm³. Because automobile bodies have complex geometrical shapes, it is extremely difficult to move the bodies within a low energy electron beam in a manner sufficient to create all the lines of sight that are necessary to cure the coatings thereon. The short range in air of low energy electrons increases this difficulty. Furthermore, low energy beams lack the penetration necessary to cure relatively thick patches of coating that naturally occur in surface cracks and crevices. A much higher energy is required, particularly since it is often necessary to penetrate through one or more thicknesses of the automotive steel body (e.g., 0.8 mm thickness, density 7.85 g/cm³) to cure the shadowed paint surfaces.

In the instant invention, at least one coating on the automobile body is an electron beam curable coating or an X-ray curable coating. In one embodiment the color base coat is electron or X-ray curable. In another embodiment, the color base coat and the clear coat are electron or X-ray curable. In either embodiment, the base coat and clear coat may be cured separately or simultaneously. The electron beam curable coating is cured with one or more medium to high power, medium to high energy electron beams. Alternatively, the curable coating is cured with an X-ray field generated by a medium to high power, medium to high energy electron beam. Preferably, the electron beam is a high energy, high power beam.

5.3 Electron and X-Ray Curable Coatings

Electron curable and X-ray curable coatings are basically synonymous. While the physics may differ, the reaction chemistry is basically the same. However, electron beam has traditionally been favored over X-ray due to the high power and energy requirements needed to convert electrons into X-rays. Accordingly, the prior art, and this discussion, focuses on electron beam curable films. However, it should be understood that most electron beam curable resins are also X-ray curable.

Electron beam and X-ray curable coatings are known in the art and commercially available. For example, electron beam curable systems that use acrylates in waterborne formulations such as water-soluble coatings or aqueous emulsions are available.

Electron beam curable coatings are generally sprayed onto an object and then cured (crosslinked and/or polymerized) by radiation from an electron beam accelerator. The curing process takes place almost instantaneously when radiation is applied, rather than the minutes, hours, and even days that conventional coatings take. Because curing takes place so quickly, it is advisable to allow a sufficient amount of time between application and curing for the coating to flow-out and achieve maximum gloss. However, during this flow-out time, emissions of VOCs could conceivably take place.

Electron beam and X-ray curing is not affected by coating color or opacity. The electrons penetrate pigmented coatings effectively to cure coatings in short exposure times.

Electron beam and X-ray curable coatings can use 100 percent reactive liquids, thereby eliminating the need for non-reactive solvents altogether. However, certain resins can volatilize and become VOCs, so the ability to achieve zero VOC formation depends on the formulation. Electron beam and X-ray cured coatings generally consist of the following components: (i) an oligomer or prepolymer containing double-bond unsaturation; and (ii) a reactive solvent (i.e., one or more monomers with varying degrees of unsaturation). Preferably, the oligomer or prepolymer contains acrylate or methacrylate groups. Electron beam curable coatings can also contain a photoinitiator, pigments, dyes and other additives.

One type of electron beam or X-ray curable coating uses free-radicals in the polymerization process. Free radicals are highly reactive molecules that contain an unpaired electron. Free radicals are produced directly by exposure of reactants to the electron beam or indirectly from photoinitiator molecules that undergo photochemical reactions upon exposure to the electron beam. Free radicals react with activated double bonds, such as acrylate groups, activating a chain reaction that causes crosslinking and/or polymerization.

A second type of electron beam or X-ray curable coating uses cationic polymerization. This process uses salts of complex organic molecules to initiate cationic chain polymerization in resins and monomers containing epoxides (oxirane rings). Acrylic alkene double bonds and oxirane rings can be activated by electron beam radiation with or without the use of a photoinitiator.

Resins used in conventional solvent-based coatings can be chemically modified to become electron beam curable. For example, epoxides, polyesters, polyurethanes, polyethers, and other materials can be so modified by introducing acrylate functionalities. The oligomers most commonly found in today's electron beam curable formulations are acrylated urethanes, epoxies, polyesters and silicones. Typically these functionalities are obtained by reacting acrylic acid with alcohol groups or by reacting hydroxyethyl acrylate with acid groups. The general physical and chemical characteristics of the resins are retained after modification.

5.4 High Power, Medium to High Energy Electron Beams

Accelerators are machines that use electrical energy to generate free electrons, accelerate them to high speeds (thereby endowing them with high kinetic energies) and direct them at materials typically carried on a conveyor or another type of flow-through system. The energetic electrons penetrate the material, excite and ionize the atoms and molecules and initiate chemical reactions in the material. Alternatively, given a beam of sufficient power and energy, the electrons can be directed to a conversion target, such as a tantalum plate, that converts the electrons into X-rays which serve the same function but have greater penetrating power than electrons.

Accelerators are similar to TV sets or medical X-ray machines in the way they generate electrons. All produce a cloud of free electrons by heating a negative cathode inside a vacuum chamber. Once generated, the negatively-charged electrons are repelled by the negative electrical potential on the cathode and are attracted by the grounded anode plate. In a direct accelerator, like the RDI DYNAMITRON®, the negative voltage applied to the cathode determines the total kinetic energy of the electrons. In an microwave linear (linac) accelerator, or a radio frequency (RF) accelerator such as an IBA Rhodotron®, the electrons are accelerated to a relatively low energy (typically 25 to 50 keV) and then injected into an electron accelerating structure and accelerated to higher kinetic energies with alternating electric fields. The accelerated electrons escape through a thin metallic window that is mounted in the grounded anode plate and proceed through the air towards the material to be treated.

Accelerator output is usually specified in watts or kilowatts of power. Other factors being equal, a 200 kW accelerator processes four times as much material as a 50 kW accelerator per unit time. Thus, low energy accelerators (e.g., 50 to 300 keV) are very restricted in application because low energy means low electron penetration.

Electrons have a predictable penetration depth, or range, in a given material. The range is affected by two parameters: electron energy and product density. The penetration is proportional to the energy and inversely proportional to the density. The basic formula which describes penetration in plastic materials for equal entrance and exit doses is as follows:
Penetration=[0.414E−0.142)/d]
where “E” is the beam energy in MeV and “d” is the density in g/cm³. Although exact penetration will vary with density and atomic number, this generally correlates to about 3 to 4 millimeters of plastic material penetration per MeV.

Low energy accelerators do not generate beams with sufficient energy to penetrate and cure complex three dimensional high-density objects such as automobile bodies. Low energy accelerators are basically limited to curing thin coatings in direct line of sight applications. It is extremely difficult if not impossible for one beam, or even a few beams, to have a direct line of sight to every exposed surface area of an automobile body, much less multiple types of automobile bodies. Shadowing, caused by bends, curves and folds in the car surface hide at least some of the exposed surface. Thus the lack of penetration power in conventional accelerators has been considered too problematic for this purpose.

In contrast, the accelerators used in the invention are medium to high power, medium to high energy electron beam accelerators. Preferably, the accelerators are high power, high energy electron beam accelerators. The electron beams employed in the invention typically have energies of more than 1 MeV, preferably at least 3 MeV, more preferably at least 5 MeV and as high as 10 or 12 MeV. This is much higher than the conventional low energy beams used in the coating arts which are typically in the 50 to 300 keV energy range. The electron beams employed in the invention typically have power capabilities of at least 1 kW, preferably at least 10 kW, more preferably at least 35 kW, even more preferably at least 80 kW, ideally at least 150 kW, and, in at least in one embodiment, as high as 200 kW to 700 kW. These beams can penetrate multiple layers of metal and, therefore, are not handicapped by the shadowing effects in automobile bodies. These beams can penetrate multiple layers of steel plate to reach portions of the automobile body hidden from the direct line of sight of the beam due to curves, bends, or folds in the three dimensional structure.

Suitable accelerators were recently introduced by IBA. The Rhodotron® TT 100 generates up to 35 kW at 10 MeV (3.5 mA). The Rhodotron® TT 200 generates up to 100 kW at 10 MeV (10 mA) and up to 100 kW at 5 MeV (20 mA). The Rhodotron® TT 300 generates up to 200 kW at 10 MeV (20 mA) and up to 135 kW at 5 MeV (27 mA). The beam powers for the Rhodotron® TT 200 and TT 300 are guaranteed to 80 kW and 150 kW, respectively, for continuous industrial service. IBA has built, and is in the final stages of testing, the world's first very high power industrial accelerator, the Rhodotron® TT 1000, rated at 7 MeV and 700 kW. The Rhodotron® family of accelerators are described in U.S. Pat. No. 5,107,221, the entirety of which is incorporated herein by reference.

5.5 Beam Arrangements

The medium to high power, medium to high energy electron beam accelerators can be deployed in numerous arrangements. Three arrangements are detailed below:

5.5.1 Plant Concept #1: Multiple Medium-to-High Energy Beam Scanning Units

In one embodiment, complete automotive bodies carried by a continuous conveyor system enter a vault which has a plurality of fixed beam scanning units (e.g., two to four or more) which deliver medium to high energy, medium to high power electron beams. These beams can emanate from the same electron beam accelerator or a plurality of electron beam accelerators. The beams emanate from opposite sides of the object to cover an area up to 3 m wide. The accelerators are located in rooms adjoining the vault. The scanning units are strategically located within the vault to ensure the delivery of a relatively uniform dose over the entire body.

Computer simulations using Monte Carlo software predict that, at a dose of 40 kGy, using a single 10 MeV, 20 mA (i.e., 200 kW) beam, a cure time of 1.64 minutes/car body (or a cure rate of 0.6 car/minute) will be achieved if the painted surface is always oriented directly toward the beam. The cure times are still quite reasonable even if several thicknesses of metal have to be penetrated prior to reaching the painted surface. Specifically the estimated cure times are 1.1, 1.1, and 2.3 min./body at depths of 1.6, 3.2, and 4.8 mm (through 2, 4, and 6 steel plate stacks, respectively, where each plate is 0.8 mm thick and has a density of 7.85 g/cm³). The additive effect of the dose distribution of two or more beams from different directions has not been taken into consideration in these calculations. These rates would be halved if two accelerators were used and halved again if a lower dose of 20 kGy was desired. For example, the use of 400 kW of beam power (e.g., two 10 MeV 200 kW accelerators) to achieve a dose requirement of 20 kGy would yield cure rates that are about 4 times faster than those shown above.

Two beams with an energy between 5 and 10 MeV could prove satisfactory. Three to four beams would be even more effective.

In one embodiment, the car body is rotated at a fixed angle (e.g., 45°) as it passes through the treatment zone, in order to improve the dose uniformity. One pass through two beams with this body orientation should be sufficient. Alternatively, two passes at half the total dose per pass (i.e., twice the conveyor speed) could be applied to opposite rotations of the body to obtain a more uniform dose distribution. Two passes are routinely done at many electron beam facilities today. This requires a loop in the conveyor system outside the vault, and a suitable computerized product-tracking system. The total throughput of the facility would be essentially unchanged from a single-pass system.

5.5.2 Plant Concept #2: Single Medium-to-High Energy Scan Horn

In another embodiment, complete automotive bodies carried by a continuous conveyor system enter a vault where a single accelerator and scanning unit is used. In this embodiment, the scanner can be positioned to point in any horizontal, vertical or angled direction. Preferably, the scanner is mounted vertically pointing downward in the center of the vault or positioned horizontally pointing sideways toward the center of the vault. In order to achieve a uniform dose distribution, the conveyor is programmed to tilt the body to face the beam as it moves through the vault. In other words, the body does a dance in the beam to decrease the total surface area hidden from the beam's direct line of sight. In one embodiment, the body is tilted up to 45° degrees. In another embodiment, the body is tilted on two axes.

This can be a dynamic program, and may require two or more passes through the vault to achieve the same overall throughput for the same total beam power compared to the use of multiple scan horns. The advantage of this concept compared to the use of multiple scan horns is that a lower energy beam is possible since the beam penetration requirements can be lessened. This would lower heating effects and increase throughput. Capital cost would be slightly lower due to the fewer accelerators required, and possibly reduced shielding. The downside is that a more complex product handling system is required. All other factors should be comparable to the use of multiple scan horns.

5.5.3 Plant Concept No. 3: X-Ray Curing using a Very High Power Accelerator

In one embodiment, one or more high power accelerators with a horizontal or vertical scan horn is fitted with an X-ray conversion target, directing the X-rays into the vault, essentially bathing the entire vault in an X-ray field. The newest generation of medium to high power, medium to high energy electron beams makes it possible to generate large quantities of X-rays. Since high power and high energy facilitate X-ray conversion, high power high energy beams are preferred. In this regard, IBA has built and is currently in the final stages of testing the world's first very high power industrial accelerator, the Rhodotron® TT 1000, rated at 7 MeV and 700 kW.

X-rays offer the ability to penetrate thicknesses about an order of magnitude greater than is possible using electrons. In general, photons from X-rays would be expected to have a similar curing effect as bombarding electrons. The downside is that the electron beam to X-ray energy conversion efficiency is poor, in the 5% to 15% range (for energies of 10 MeV or less) depending on the energy of the electron beam used to generate the X-rays. However, processing speeds are still reasonably high, especially when employing a very high power accelerator such as the Rhodoton® TT 1000.

The advantage of this concept over the previous concepts, where the coatings on the automobile body are cured with an electron beam, is the ability to use a simple product handling system with only one scan horn and little likelihood that uniform penetration throughout the body will not be achieved. Also, since a smaller fraction of the total energy produced will be absorbed by the steel, the temperature increase will be less than with direct electron beam curing. Drawbacks to the X-ray method include high electrical requirements of about 1,500 kW, and somewhat increased shielding requirements.

Computer simulations using Monte Carlo software predict that, at a dose of 40 kGy, using a single high power X-ray source from a 7 MeV 700 kW beam, cure times of about 12, 13, and 14 minutes/body would be achieved at depths of 1.6, 3.2, and 4.8 mm (representing 2, 4, and 6 metal thicknesses, respectively). These times would be halved at a dose of 20 kGy, and would be halved again if two accelerators were used. Thus, a four-accelerator system has the potential to have a curing time in the 1.5 to 2 minutes/body range.

5.6 Conveyor System

Any known conveyor system can be employed to move the automotive bodies through the maze. A mix of overhead and inverted power and free conveyors and chain conveyors is typical. Suitable conveyor systems are commercially available from companies such as Jervis Webb. The principle requirement of the conveyor system is that it is sufficient to move and support the body throughout the maze and is able to control the speed and angle of the body through the beam to insure uniform dosing. The applied dose is inversely proportional to the speed of the conveyor through the beam.

5.7 Maze

One method to assure that all of the radiation is contained within the vault involves passing the bodies pass through a “maze” prior to entering the vault. This vault and maze are designed to create four or five scatterings from interior surfaces to reduce the level of radiation at the entrance or exit of the maze down to background levels. Computer codes are commercially available that can accurately model radiation levels outside the vault and maze for any particular facility design.

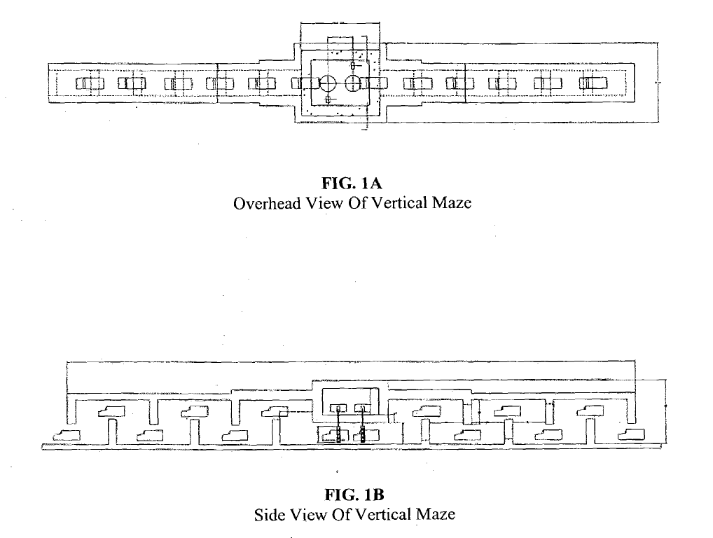

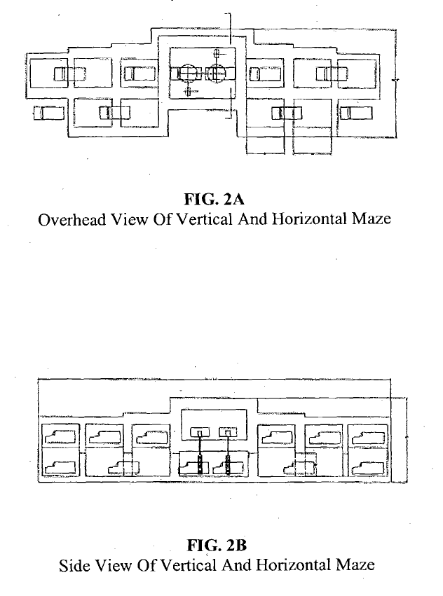

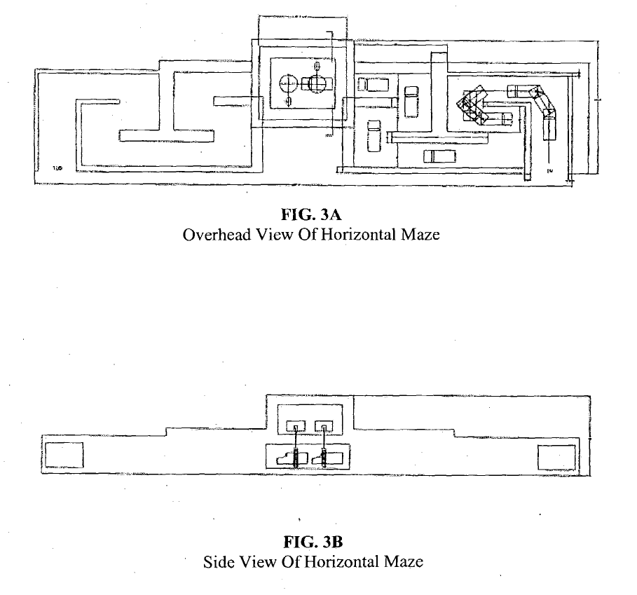

FIGS. 1A, 1B, 2A, 2B, 3A and 3B show overhead and side views of three possible layouts for such a facility. The maze may be horizontal, vertical, or a combination of both. FIGS. 1A and 1B show a “straight-through” arrangement with a vertical maze. FIGS. 2A and 2B show a combined vertical and horizontal maze. FIGS. 3A and 3B show a horizontal maze where the bodies turn as they pass around the corners of the maze. The bodies can continuously travel through the maze and vault in one orientation, or can turn as they pass through the maze. Many other concepts are possible. These are only three examples of possible configurations. The concrete walls are thicker near the scanning units and thinner closer to the maze entrance-exit. Using a denser shielding material, such as steel or lead, instead of concrete would reduce the necessary wall thickness and thus the size of the facility, albeit at a somewhat higher capital cost.

Radiation attempting to leak from the vault travels in a straight line, but can scatter from internal surfaces. These layouts assume that five scatterings from internal surfaces are required to attenuate the dose down to background levels. This may be a conservative estimate. It is possible that only four scatterings are required, which would result in a shorter maze. The interior dimensions shown for the facility should be satisfactory for full-size vehicle bodies, such as SUVs.

5.8 Heating

The adiabatic temperature rise of a block of steel is about 2.27° C. per kGy of dose delivered into iron. Therefore, a 40 kGy dose would result in an instantaneous temperature increase of 91° C. over ambient temperature, i.e. to a maximum temperature of about 120° C. This temperature rise should be acceptable (since painted bodies are presently subjected to higher temperatures than this in current oven baking processes). Furthermore, an air (or other) cooling system can reduce this temperature rise. Only a small portion of the entire surface area of the car body is subjected to the beam energy at any one instant, and a lower required dose would also lower the temperature rise proportionately. For example a dose of 20 kGy would result in the maximum theoretical temperature rise above ambient of about 45° C. Overall, the temperature rise is not a serious issue.

5.9 Oxygen Free Environments

The cure rate of electron beam cured coatings can be hindered by oxygen present in the radiation chamber. The electrons cure the coatings by generating free radicals. Oxygen can slow this process because it is a free radical scavenger. If this effect is significant, the oxygen level can be reduced by pulsing inert gas (such as nitrogen gas) over the product and/or by vacuum pumping. Alternatively, the product can be packaged in a bag sealed by vacuum or filled with an inert gas. It is preferable to select electron beam curable coatings whose rate of cure is not significantly impacted by oxygen.

5.10 Benefits of the Invention

The methods of the instant invention provide a number of benefits. First and foremost, the methods enable the elimination or reduction of non-reactive solvent used in the automobile coating industry. As stated, solvents generate fumes which are a fire hazard and a source of HAPs and VOCs, necessitating expensive and energy consuming VOC abatement equipment. Second, electron beam and X-ray provide extremely rapid curing—potentially less than a minute per car body—as well as instantaneous startup and shutdown capabilities. This increases throughput compared to conventional thermal ovens which take many minutes to ramp up, cure and ramp down. Third, electron beam and X-ray curing are low temperature processes. Internal heat is generated in the product, but these processes are still friendlier to heat sensitive substances such as thermoplastics. Heat sensitive substances can often be found in various parts of the body or in the underlying coatings. Fourth, the invention permits the use of radiation curable coatings which, as a class, tend to have a longer shelf life and a longer pot life before application because these coatings are often single component systems. Fifth, in this same vein, radiation curable coatings tend to exhibit better physical properties, such as hardness, solvent resistance, stain resistance and abrasion resistance. In fact, the lower volatile content in radiation curable coatings gives them higher gloss, better build, and lower shrinkage. Sixth, electron beam accelerators are more energy efficient compared to thermal ovens. The heat energy required to evaporate solvents or induce thermal reactions in conventional systems is orders of magnitude higher than the energy used in electron beam systems because of the inefficiency of the ovens. A 10 MeV, 200 kW accelerator requires about 500 kW of electrical power. If one estimates a cost of about 5 cents/kW−hr, this amounts to $25/hour. This is a substantial cost savings compared to thermal ovens. Seventh, electron beam accelerators require less floor space than conventional thermal ovens and the capital cost for electron beam curing facilities is comparable to oven curing facilities.

5.11 Other Applications

Although the invention has been described largely in the context of curing coatings on automotive bodies, it is not so restricted. Similar problems are encountered when coating other large three dimensional objects which are solved by the invention. Thus, the invention is applicable to curing coatings on any complex three dimensional structure including furniture (cupboard, desks, etc.), lawn mower frames, boats, bicycles, construction equipment, landscaping equipment, etc. The invention is especially applicable to curing coatings on any three dimensional object formed from a bent, curved, or folded sheet material. Suitable sheet materials include metal, plastic, fiber glass, carbon fiber, rubber, wood or a mixture thereof. An especially suitable sheet material is steel.

Accordingly, another aspect of the invention is a method for curing one or more coatings on an object made of a sheet material that is curved, bent or folded into a three dimensional structure comprising: (i) coating the object with at least one electron or X-ray curable coating; and (ii) moving the object one or more times through one or more medium to high power, medium to high energy electron beams or X-ray fields, where at least one of the electron beams and/or X-ray fields is capable of penetrating through multiple layers of said sheet material to cure areas of coating not in the visible line of sight of said beam or field. Preferably, all of the electron beams and/or X-ray fields are capable of penetrating through multiple layers of said sheet material to cure areas of coating not in the line of sight of said beam or field. The high power, medium to high energy X-ray fields, if present, are generated by striking a metal target with a medium to high power, medium to high energy electron beam. In one embodiment, the sheet material has an equivalent area density that is equal to or greater than the equivalent area density of 3 mm of plastic material. In another embodiment, the sheet material has an equivalent area density that is equal to or greater than the equivalent area density of 0.4 mm of steel. In yet another embodiment, the sheet material is steel.

Another aspect of the invention is a facility that performs any one of the methods described above. Accordingly, the invention includes a plant that comprises the following components: (i) one or more three dimensional objects made from a sheet material that is curved, bent or folded into a three dimensional structure and coated with one or more electron beam or X-ray curable coatings; (ii) a conveyor system for moving said one or more objects past an electron beam and/or X-ray field; and (iii) one or more accelerators capable of generating one or more medium to high power, medium to high energy electron beams and/or X-ray fields, where at least one of said beams and/or fields is capable of penetrating through multiple layers of said sheet material to cure areas of coating not in the visible line of sight of said beam or fields. Preferably, all of the electron beams and/or X-ray fields are capable of penetrating through multiple layers of said sheet material to cure areas of coating not in the line of sight of said beam or field. The high power, medium to high X-ray fields, if present, are generated by striking a metal target with a medium to high power, medium to high energy electron beam. In one embodiment, the sheet material has an equivalent area density that is equal to or greater than the equivalent area density of 3 mm of plastic material. In another embodiment, the sheet material has an equivalent area density that is equal to or greater than the equivalent area density of 0.4 mm of steel. In yet another embodiment, the sheet material is steel.

### 6.0 EXAMPLES

### 6.1 Example 1

### Monte Carlo Simulations (Electron Beam)

Calculations were done to estimate the time required to cure coatings on automobile bodies with high-energy electrons. Specifically, the ITS3 TIGER Monte Carlo code was used to calculate the depth-dose distribution in an iron absorber irradiated with 5, 7 and 10 MeV electron beams. In each case, the assumed thickness of the iron was greater than the maximum range of the primary electrons. The surface of the iron was assumed to be covered with an acrylic material to evaluate the difference between the energy deposition (proportional to the absorbed dose) in the coating versus that in the iron.

The TIGER code only gives one-dimensional dose distributions in flat plates of material with unbounded areas. The output data can be used to calculate the area throughput rates for irradiating large flat surfaces, and to show the variation in absorbed dose within the absorbing materials. However, dose variations at the edges of finite plates or objects with different shapes cannot be evaluated with this code. Such three-dimensional calculations can be done with the ITS3 ACCESS Monte Carlo code (i.e., the CCC-467/ITS3 Code Package, Integrated TIGER Series of Coupled Electron/Photon Monte Carlo Transport Codes available from the Radiation Safety Information Computational Center).

Three Monte Carlo calculations were made with 5, 7 and 10 MeV electrons incident on thick iron absorbers. Iron was specified instead of steel to simplify the input data. The difference between steel and iron is negligible for these calculations. A 50 micron titanium electron beam window was included along with an air space of 100 cm between the window and the iron absorber. The electron energies deposited in the beam window and air gap were negligible at these input energies, and they could have been omitted from the calculations without changing the conclusions.

The beam window and the air space were designated as single zones (layers). The 50 micron acrylic coating was subdivided into two zones, while the thick iron absorbers were subdivided into multiple zones, each 0.2 mm thick, to show the depth-dose distribution within the iron. These calculations confirmed the expectation of a higher dose in an organic coating versus an iron absorber. Each Monte Carlo calculation included 500,000 electron histories. The running times ranged from about 21 to 37 minutes using a personal computer with a 1.7 GHz Pentium 4 processor.

The ITS3 TIGER output data file gives the energy deposition per electron in each zone of absorbing material in units of MeV cm²/g, or MeV per unit area density in g/cm². The entrance and exit depths of each zone are given as a dimensionless ratio, Z/R, which is the depth Z divided by the maximum electron range R in that material, and also in area density units of g/cm², which is the thickness in cm times volume density in g/cm³.

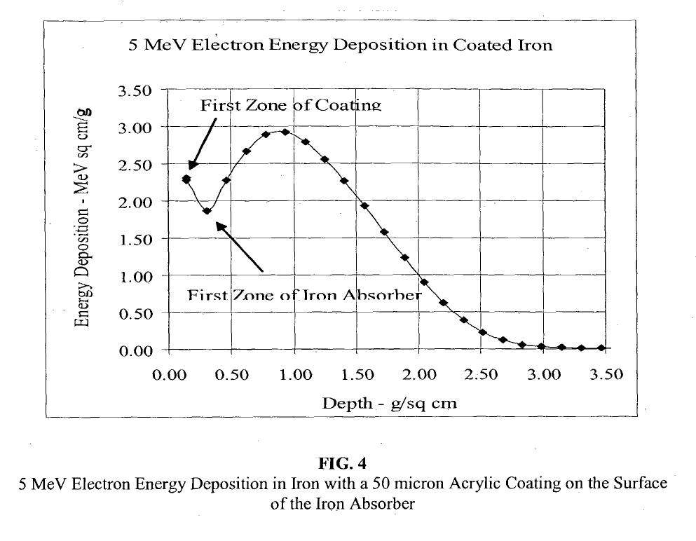

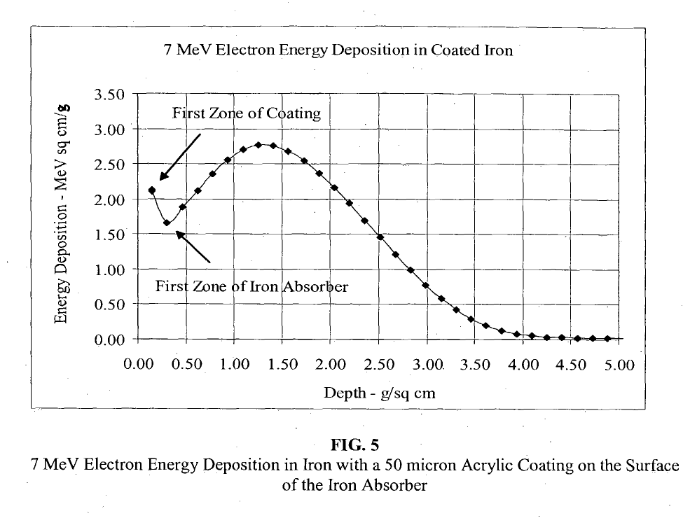

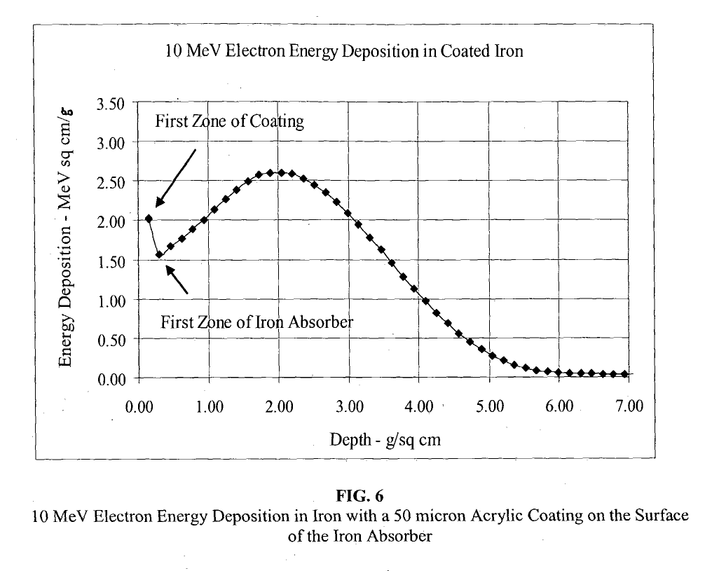

The results of the Monte Carlo calculations are partially plotted in FIGS. 4, 5 and 6. The raw data is set forth below:

TABLE 1
Processing Times for Curing Automobile Body Coatings with
Electrons Electron Energy 5 MeV, Beam Current 40 mA,
Beam Power 200 kW, Dose 40 kGy, Width 2 m, Length 5 m

| | | | | | | | Curing | Curing |
|---|---|---|---|---|---|---|---|---|
| Steel | Energy | Ratio | Iron | Acrylate | Area | Line | Rate | Time |
| Depth | Deposition | Surface/ | Area K Factor | Area K Factor | Rate | Speed | car | min/car |
| mm | MeV cm²/g | Depth | kGy m²/mA min | kGy m²/mA min | m²/min | m/min | body/min | body |
| 0.20 | 1.86 | 1.000 | 11.1876 | 13.8726 | 13.873 | 6.936 | 1.3873 | 0.72 |
| 0.40 | 2.28 | 1.223 | 13.6860 | 16.9706 | 16.971 | 8.485 | 1.6971 | 0.59 |
| 0.60 | 2.67 | 1.430 | 15.9996 | 19.8395 | 19.840 | 9.920 | 1.9840 | 0.50 |
| 0.80 | 2.89 | 1.549 | 17.3286 | 21.4875 | 21.487 | 10.744 | 2.1487 | 0.47 |
| 1.00 | 2.92 | 1.567 | 17.5290 | 21.7360 | 21.736 | 10.868 | 2.1736 | 0.46 |
| 1.20 | 2.79 | 1.494 | 16.7178 | 20.7301 | 20.730 | 10.365 | 2.0730 | 0.48 |
| 1.40 | 2.56 | 1.373 | 15.3642 | 19.0516 | 19.052 | 9.526 | 1.9052 | 0.52 |
| 1.60 | 2.27 | 1.215 | 13.5906 | 16.8523 | 16.852 | 8.426 | 1.6852 | 0.59 |
| 1.80 | 1.93 | 1.036 | 11.5914 | 14.3733 | 14.373 | 7.187 | 1.4373 | 0.70 |
| 2.00 | 1.58 | 0.846 | 9.4614 | 11.7321 | 11.732 | 5.866 | 1.1732 | 0.85 |
| 2.20 | 1.23 | 0.661 | 7.3902 | 9.1638 | 9.164 | 4.582 | 0.9164 | 1.09 |
| 2.40 | 0.90 | 0.482 | 5.3931 | 6.6874 | 6.687 | 3.344 | 0.6687 | 1.50 |
| 2.60 | 0.62 | 0.331 | 3.7059 | 4.5953 | 4.595 | 2.298 | 0.4595 | 2.18 |
| 2.80 | 0.39 | 0.211 | 2.3581 | 2.9240 | 2.924 | 1.462 | 0.2924 | 3.42 |
| 3.00 | 0.23 | 0.121 | 1.3570 | 1.6826 | 1.683 | 0.841 | 0.1683 | 5.94 |
| 3.20 | 0.12 | 0.064 | 0.7182 | 0.8906 | 0.891 | 0.445 | 0.0891 | 11.23 |
| 3.40 | 0.06 | 0.032 | 0.3564 | 0.4419 | 0.442 | 0.221 | 0.0442 | 22.63 |
| 3.60 | 0.03 | 0.016 | 0.1796 | 0.2227 | 0.223 | 0.111 | 0.0223 | 44.90 |
| 3.80 | 0.02 | 0.010 | 0.1111 | 0.1377 | 0.138 | 0.069 | 0.0138 | 72.62 |
| 4.00 | 0.01 | 0.008 | 0.0886 | 0.1098 | 0.110 | 0.055 | 0.0110 | 91.05 |

TABLE 2
Processing Times for Curing Automobile Body Coatings with
Electrons (Electron Energy 7 MeV, Beam Current 28.6 mA,
Beam Power 200 kW, Dose 40 kGy, Width 2 m, Length 5 m)

| | | | | | | | Curing | Curing |
|---|---|---|---|---|---|---|---|---|
| Steel | Energy | Ratio | Iron | Acrylate | Area | Line | Rate | Time |
| Depth | Deposition | Surface/ | Area K Factor | Area K Factor | Rate | Speed | car | min/car |
| mm | MeV cm²/g | Depth | kGy m²/mA min | kGy m²/mA min | m²/min | m/min | body/min | body |
| 0.20 | 1.666 | 1.000 | 9.993 | 12.791 | 9.146 | 4.573 | 0.9146 | 1.09 |
| 0.40 | 1.883 | 1.131 | 11.300 | 14.464 | 10.342 | 5.171 | 1.0342 | 0.97 |
| 0.60 | 2.117 | 1.271 | 12.704 | 16.261 | 11.627 | 5.813 | 1.1627 | 0.86 |
| 0.80 | 2.351 | 1.412 | 14.108 | 18.059 | 12.912 | 6.456 | 1.2912 | 0.77 |
| 1.00 | 2.559 | 1.536 | 15.354 | 19.653 | 14.052 | 7.026 | 1.4052 | 0.71 |
| 1.20 | 2.704 | 1.624 | 16.225 | 20.767 | 14.849 | 7.424 | 1.4849 | 0.67 |
| 1.40 | 2.765 | 1.660 | 16.592 | 21.238 | 15.185 | 7.593 | 1.5185 | 0.66 |
| 1.60 | 2.758 | 1.656 | 16.550 | 21.184 | 15.146 | 7.573 | 1.5146 | 0.66 |
| 1.80 | 2.681 | 1.609 | 16.084 | 20.587 | 14.720 | 7.360 | 1.4720 | 0.68 |
| 2.00 | 2.546 | 1.529 | 15.275 | 19.553 | 13.980 | 6.990 | 1.3980 | 0.72 |
| 2.20 | 2.373 | 1.424 | 14.235 | 18.221 | 13.028 | 6.514 | 1.3028 | 0.77 |
| 2.40 | 2.171 | 1.303 | 13.024 | 16.670 | 11.919 | 5.960 | 1.1919 | 0.84 |
| 2.60 | 1.942 | 1.166 | 11.654 | 14.917 | 10.666 | 5.333 | 1.0666 | 0.94 |
| 2.80 | 1.697 | 1.019 | 10.184 | 13.035 | 9.320 | 4.660 | 0.9320 | 1.07 |
| 3.00 | 1.459 | 0.876 | 8.755 | 11.206 | 8.012 | 4.006 | 0.8012 | 1.25 |
| 3.20 | 1.216 | 0.730 | 7.295 | 9.337 | 6.676 | 3.338 | 0.6676 | 1.50 |
| 3.40 | 0.985 | 0.591 | 5.911 | 7.566 | 5.409 | 2.705 | 0.5409 | 1.85 |
| 3.60 | 0.773 | 0.464 | 4.636 | 5.935 | 4.243 | 2.122 | 0.4243 | 2.36 |
| 3.80 | 0.585 | 0.351 | 3.509 | 4.491 | 3.211 | 1.606 | 0.3211 | 3.11 |
| 4.00 | 0.424 | 0.254 | 2.543 | 3.254 | 2.327 | 1.163 | 0.2327 | 4.30 |
| 4.20 | 0.295 | 0.177 | 1.771 | 2.266 | 1.621 | 0.810 | 0.1621 | 6.17 |
| 4.40 | 0.198 | 0.119 | 1.188 | 1.521 | 1.088 | 0.544 | 0.1088 | 9.19 |
| 4.60 | 0.127 | 0.076 | 0.764 | 0.977 | 0.699 | 0.349 | 0.0699 | 14.31 |
| 4.80 | 0.080 | 0.048 | 0.483 | 0.618 | 0.442 | 0.221 | 0.0442 | 22.63 |
| 5.00 | 0.051 | 0.031 | 0.309 | 0.395 | 0.282 | 0.141 | 0.0282 | 35.40 |

TABLE 3
Processing Times for Curing Automobile Body Coatings with
Electrons (Electron Energy 10 MeV, Beam Current 20 mA,
Beam Power 200 kW, Dose 40 kGy, Width 2 m, Length 5 m)

| | | | | | | | Curing | Curing |
|---|---|---|---|---|---|---|---|---|
| Steel | Energy | Ratio | Iron | Acrylate | Area | Line | Rate | Time |
| Depth | Deposition | Surface/ | Area K Factor | Area K Factor | Rate | Speed | car | min/car |
| mm | MeV cm²/g | Depth | kGy m²/mA min | kGy m²/mA min | m²/min | m/min | body/min | body |
| 0.20 | 1.561 | 1.000 | 9.367 | 12.177 | 6.088 | 3.044 | 0.6088 | 1.64 |
| 0.40 | 1.668 | 1.068 | 10.007 | 13.009 | 6.504 | 3.252 | 0.6504 | 1.54 |
| 0.60 | 1.767 | 1.132 | 10.601 | 13.782 | 6.891 | 3.445 | 0.6891 | 1.45 |
| 0.80 | 1.881 | 1.205 | 11.286 | 14.672 | 7.336 | 3.668 | 0.7336 | 1.36 |
| 1.00 | 2.000 | 1.281 | 12.000 | 15.600 | 7.800 | 3.900 | 0.7800 | 1.28 |
| 1.20 | 2.135 | 1.367 | 12.808 | 16.650 | 8.325 | 4.162 | 0.8325 | 1.20 |
| 1.40 | 2.265 | 1.451 | 13.590 | 17.667 | 8.834 | 4.417 | 0.8834 | 1.13 |
| 1.60 | 2.388 | 1.530 | 14.330 | 18.630 | 9.315 | 4.657 | 0.9315 | 1.07 |
| 1.80 | 2.492 | 1.596 | 14.949 | 19.434 | 9.717 | 4.858 | 0.9717 | 1.03 |
| 2.00 | 2.571 | 1.647 | 15.426 | 20.054 | 10.027 | 5.013 | 1.0027 | 1.00 |
| 2.20 | 2.598 | 1.664 | 15.585 | 20.261 | 10.130 | 5.065 | 1.0130 | 0.99 |
| 2.40 | 2.604 | 1.668 | 15.623 | 20.310 | 10.155 | 5.077 | 1.0155 | 0.98 |
| 2.60 | 2.583 | 1.655 | 15.500 | 20.150 | 10.075 | 5.037 | 1.0075 | 0.99 |
| 2.80 | 2.526 | 1.618 | 15.155 | 19.702 | 9.851 | 4.926 | 0.9851 | 1.02 |
| 3.00 | 2.445 | 1.566 | 14.672 | 19.073 | 9.537 | 4.768 | 0.9537 | 1.05 |
| 3.20 | 2.350 | 1.505 | 14.097 | 18.326 | 9.163 | 4.582 | 0.9163 | 1.09 |
| 3.40 | 2.226 | 1.426 | 13.354 | 17.360 | 8.680 | 4.340 | 0.8680 | 1.15 |
| 3.60 | 2.088 | 1.337 | 12.526 | 16.284 | 8.142 | 4.071 | 0.8142 | 1.23 |
| 3.80 | 1.945 | 1.246 | 11.671 | 15.172 | 7.586 | 3.793 | 0.7586 | 1.32 |
| 4.00 | 1.784 | 1.143 | 10.705 | 13.917 | 6.958 | 3.479 | 0.6958 | 1.44 |
| 4.20 | 1.626 | 1.041 | 9.755 | 12.681 | 6.341 | 3.170 | 0.6341 | 1.58 |
| 4.40 | 1.454 | 0.931 | 8.723 | 11.340 | 5.670 | 2.835 | 0.5670 | 1.76 |
| 4.60 | 1.286 | 0.824 | 7.718 | 10.033 | 5.017 | 2.508 | 0.5017 | 1.99 |
| 4.80 | 1.131 | 0.724 | 6.785 | 8.821 | 4.411 | 2.205 | 0.4411 | 2.27 |
| 5.00 | 0.969 | 0.620 | 5.811 | 7.554 | 3.777 | 1.889 | 0.3777 | 2.65 |
| 5.20 | 0.822 | 0.527 | 4.933 | 6.413 | 3.207 | 1.603 | 0.3207 | 3.12 |
| 5.40 | 0.687 | 0.440 | 4.121 | 5.358 | 2.679 | 1.339 | 0.2679 | 3.73 |
| 5.60 | 0.561 | 0.359 | 3.367 | 4.377 | 2.189 | 1.094 | 0.2189 | 4.57 |
| 5.80 | 0.452 | 0.290 | 2.715 | 3.529 | 1.765 | 0.882 | 0.1765 | 5.67 |
| 6.00 | 0.354 | 0.227 | 2.126 | 2.764 | 1.382 | 0.691 | 0.1382 | 7.24 |
| 6.20 | 0.273 | 0.175 | 1.641 | 2.133 | 1.067 | 0.533 | 0.1067 | 9.38 |
| 6.40 | 0.208 | 0.133 | 1.250 | 1.625 | 0.812 | 0.406 | 0.0812 | 12.31 |
| 6.60 | 0.158 | 0.101 | 0.947 | 1.231 | 0.615 | 0.308 | 0.0615 | 16.25 |
| 6.80 | 0.118 | 0.076 | 0.710 | 0.924 | 0.462 | 0.231 | 0.0462 | 21.65 |
| 7.00 | 0.089 | 0.057 | 0.532 | 0.691 | 0.346 | 0.173 | 0.0346 | 28.93 |

These depth-dose distributions show that the iron thicknesses for equal entrance and exit doses are about 1.8 mm at 5 MeV, 2.8 mm at 7 MeV and 4.2 mm at 10 MeV. The volume density of the iron is 7.89 g/cm³, so the equivalent area densities are about 1.4 g/cm² at 5 MeV, 2.2 g/cm² at 7 MeV and 3.3 g/cm² at 10 MeV. The initial rise in the energy deposition is caused by the production of energetic secondary electrons within the iron. The decrease in the energy deposition at greater depths is caused by the depletion of the primary and secondary electron energies.

Values of the electron energy deposition in iron are shown in the second column of Tables 1, 2 and 3 for depth increments of 0.2 mm in iron. Ratios of the depth values to the surface values are shown in the third column. The energy depositions reach maximum values at about 1.0 mm at 5 MeV, 1.4 mm at 7 MeV and 2.4 mm at 10 MeV. The ratios of the maximum value to the surface value are about 1.57 at 5 MeV, 1.66 at 7 MeV and 1.67 at 10 MeV.

Organic coatings on automobile parts will have higher electron stopping power than that of an iron absorber. The stopping power is defined as the energy in MeV deposited by an electron in passing through a zone of material with an area density 1 g/cm². Therefore, the energy deposition in the coating, which will be exposed to the same electron fluence as the surface of the iron, should be higher than the energy deposition in the first iron zone. Assuming secondary electron equilibrium in both materials, the ratio of their energy depositions at the interface should be the same as the ratio of their electron stopping powers.

The 50 micron coating is assumed to be an acrylated polymer with a stopping power similar to that of polymethyl methacrylate. The ratio of the electron stopping power in the polymer to that in the iron is nearly independent of the electron energy, although the ratio decreases slightly as the electron energy increases. The theoretical stopping power ratios are 1.31 at 5 MeV, 1.30 at 7 MeV and 1.29 at 10 MeV. Calculated ratios of the surface energy depositions obtained from the Monte Carlo data shown in FIGS. 4, 5 and 6 are 1.24 at 5 MeV, 1.28 at 7 MeV and 1.30 at 10 MeV. The higher energy depositions in the coating are consistent with the theoretical expectations.

The area throughput rates shown in the sixth column of the tables were calculated with the following equation:
A/T=KI/D
where the area throughput rate, A/T, is in units of m²/Min, I is the electron beam current in mA and D is the absorbed dose in kGy. The electron beam power was assumed to be 200 kW in each case. Therefore, the electron beam currents were 40 mA at 5 MeV, 28.6 mA at 7 MeV and 20 mA at 10 MeV. The absorbed dose in the coating was assumed to be 40 kGy.

The factor, K, is the area processing coefficient in kGy m²/mA min, which is equal to 6 times the energy deposition in MeV cm²/g. Values of K for iron are shown in the fourth column of the tables. The K factor for the coating, shown in the fifth column, has been obtained by multiplying the K factor for iron by 1.24 in Table 1, by 1.28 in Table 2 and by 1.30 in Table 3. These are the values of the ratios of energy deposition in polymethyl methacrylate versus iron obtained from the Monte Carlo calculations (see the discussion in the previous section). The area throughput rates in the sixth column are based on the higher K factors for the acrylic coating.

The line speed shown in the seventh column is the area throughput rate divided by the conveyor width, which is assumed to be 2 meters. The car body curing rate shown in the eighth column is the line speed divided by the conveyor length per car body, which is assumed to be 5 meters. The curing time per car body is the inverse of the car body curing rate.

Based on the energy deposition in the coating at the surface of the iron, the curing time per car body would be about 0.72 minutes with 40 mA of beam current at 5 MeV, 1.01 minutes with 28.6 mA at 7 MeV and 1.64 minutes with 20 mA at 10 MeV, assuming an absorbed dose of 40 kGy in the coating, and treatment with one accelerator from one direction. The curing time would be longer if the dose were delivered through iron thicknesses greater than those for equal entrance and exit doses.

On the other hand, the curing time would be shorter if the required dose were lower, since the curing time is directly proportional to the dose. For example, if the dose could be reduced to 20 kGy instead of the 40 kGy used for these calculations, the curing times listed in the tables would be cut in half. Also, if the car body were irradiated from opposite sides with two electron accelerators, the curing times could be nearly cut in half, and the uniformity of the dose distributions could be improved.

Based on these Monte Carlo simulations, the organic coatings on complex steel structures, such as automobile bodies, can be cured by irradiation with high-energy electrons. There are several advantages of using this technique, such as shorter curing times, lower power costs and lower capital costs in comparison to conventional thermal curing.

### 6.2 Example 2

### Monte Carlo Simulations (X-Ray)

Similar calculations were done to estimate the time required to cure coatings on automobile bodies with high-energy X-rays. The results were obtained by using the ITS3 TIGER Monte Carlo code to calculate depth-dose distributions in a thick iron absorber with X-rays generated with 5, 6 and 7 MeV electrons on a typical target assembly. The assumed target structure was thick enough to stop all of the primary electrons from the accelerator. The X-ray “background” of the electron depth-dose distribution extended from the target through the iron absorber beyond the target. This residual “tail” of the depth-dose distribution provided the data needed for this report.

Initially, three Monte Carlo calculations were made with 5, 6 and 7 MeV electrons on a typical X-ray target. The assumed target materials included a 1.2 mm tantalum converter plate, a 2 mm channel of cooling water and a 2 mm stainless steel backing plate. Once again, iron was specified instead of steel to simplify the input data. The difference between steel and iron is negligible for these calculations. A titanium electron beam window of 50 microns was included along with an air gap of 15 cm between the window and the target. Another air space of 100 cm was included between the X-ray target and the iron absorber, which was assumed to be 5 cm thick. The electron energies deposited in the beam window and air gaps were negligible at these input energies, and they could have been omitted from the calculations without changing the conclusions. All of the materials, except for the iron absorber, were designated as single zones (layers) for calculating the energy depositions, while the iron absorber was subdivided into 50 zones, each 1 mm thick, to show the X-ray attenuation.

The initial calculations indicated that the assumed target structure was thick enough to stop all of the primary electrons at 5 and 6 MeV but not at 7 MeV. Consequently, another calculation was done at 7 MeV with a 1.4 mm thick tantalum converter plate, which was sufficient to stop all of the primary electrons at this energy. A fifth calculation was done at 7 MeV with a 50 micron acrylic coating on the surface of the iron absorber. This confirmed the expectation of a higher dose in an organic coating versus the iron absorber. Each Monte Carlo calculation included 500,000 electron histories. The time required for each run was about 75 minutes using a personal computer with a 1.7 GHz Pentium 4 processor.

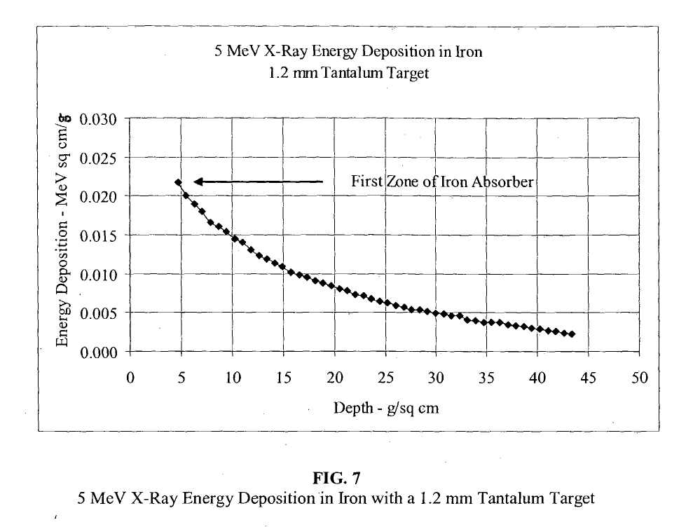

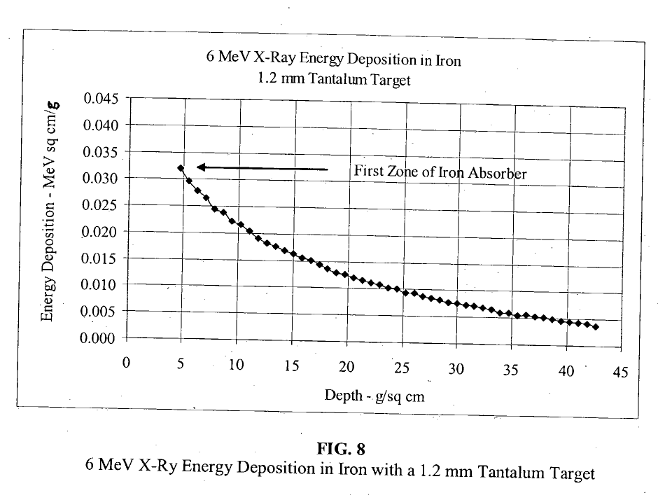

The results of these Monte Carlo calculations are partially shown in FIGS. 7, 8, 9, 10 and 11. The vertical scales have been expanded and truncated to emphasize the X-ray “tails” of the electron depth-dose distributions. The raw data is set forth below:

TABLE 4
Processing Times for Curing Automobile Body Coatings
with X-Rays (Electron Energy 5 MeV, Beam Current
100 mA, Beam Power 500 kW, Dose 40 kGy,
Width 2 m, Length 5 m)

| Steel | Energy | Ratio | Iron | Acrylate | Area | Line | Curing | Curing |
|---|---|---|---|---|---|---|---|---|
| Depth | Deposition | Surface/ | Area K Factor | Area K Factor | Rate | Speed | Rate | Time |
| mm | MeV cm²/g | Depth | kGy m²/mA min | kGy m²/mA min | m²/min | m/min | car body/min | min/car body |
| 1 | 0.02175 | 1.000 | 0.1305 | 0.1827 | 0.457 | 0.228 | 0.0457 | 21.9 |
| 2 | 0.01999 | 0.919 | 0.1200 | 0.1679 | 0.420 | 0.210 | 0.0420 | 23.8 |
| 3 | 0.01893 | 0.870 | 0.1136 | 0.1590 | 0.398 | 0.199 | 0.0398 | 25.2 |
| 4 | 0.01804 | 0.829 | 0.1083 | 0.1516 | 0.379 | 0.189 | 0.0379 | 26.4 |
| 5 | 0.01656 | 0.761 | 0.0994 | 0.1391 | 0.348 | 0.174 | 0.0348 | 28.7 |
| 6 | 0.01602 | 0.737 | 0.0961 | 0.1346 | 0.337 | 0.168 | 0.0337 | 29.7 |
| 7 | 0.01542 | 0.709 | 0.0925 | 0.1295 | 0.324 | 0.162 | 0.0324 | 30.9 |
| 8 | 0.01450 | 0.666 | 0.0870 | 0.1218 | 0.304 | 0.152 | 0.0304 | 32.9 |
| 9 | 0.01402 | 0.645 | 0.0841 | 0.1178 | 0.294 | 0.147 | 0.0294 | 34.0 |
| 10 | 0.01307 | 0.601 | 0.0784 | 0.1098 | 0.274 | 0.137 | 0.0274 | 36.4 |
| 11 | 0.01236 | 0.568 | 0.0741 | 0.1038 | 0.260 | 0.130 | 0.0260 | 38.5 |
| 12 | 0.01188 | 0.546 | 0.0713 | 0.0998 | 0.249 | 0.125 | 0.0249 | 40.1 |
| 13 | 0.01132 | 0.520 | 0.0679 | 0.0951 | 0.238 | 0.119 | 0.0238 | 42.1 |
| 14 | 0.01093 | 0.503 | 0.0656 | 0.0918 | 0.230 | 0.115 | 0.0230 | 43.6 |

TABLE 5
Processing Times for Curing Automobile Body Coatings with X-Rays
(Electron Energy 6 MeV, Beam Current 100 mA, Beam Power
600 kW, Dose 40 kGy, Width 2 m, Length 5 m)

| Steel | Energy | Ratio | Iron | Acrylate | Area | Line | Curing | Curing |
|---|---|---|---|---|---|---|---|---|
| Thickness | Deposition | Surface/ | Area K Factor | Area K Factor | Rate | Speed | Rate | Time |
| mm | MeV cm²/g | Depth | kGy m²/mA min | kGy m²/mA min | m²/min | m/min | car body/min | min/car body |
| 1 | 0.03204 | 1.000 | 0.1922 | 0.2691 | 0.673 | 0.336 | 0.0673 | 14.9 |
| 2 | 0.02955 | 0.922 | 0.1773 | 0.2482 | 0.621 | 0.310 | 0.0621 | 16.1 |
| 3 | 0.02788 | 0.870 | 0.1673 | 0.2342 | 0.585 | 0.293 | 0.0585 | 17.1 |
| 4 | 0.02652 | 0.828 | 0.1591 | 0.2228 | 0.557 | 0.278 | 0.0557 | 18.0 |
| 5 | 0.02439 | 0.761 | 0.1463 | 0.2049 | 0.512 | 0.256 | 0.0512 | 19.5 |
| 6 | 0.02380 | 0.743 | 0.1428 | 0.1999 | 0.500 | 0.250 | 0.0500 | 20.0 |
| 7 | 0.02220 | 0.693 | 0.1332 | 0.1865 | 0.466 | 0.233 | 0.0466 | 21.5 |
| 8 | 0.02155 | 0.673 | 0.1293 | 0.1810 | 0.453 | 0.226 | 0.0453 | 22.1 |
| 9 | 0.02042 | 0.637 | 0.1225 | 0.1716 | 0.429 | 0.214 | 0.0429 | 23.3 |
| 10 | 0.01916 | 0.598 | 0.1149 | 0.1609 | 0.402 | 0.201 | 0.0402 | 24.9 |
| 11 | 0.01824 | 0.569 | 0.1094 | 0.1532 | 0.383 | 0.192 | 0.0383 | 26.1 |
| 12 | 0.01756 | 0.548 | 0.1053 | 0.1475 | 0.369 | 0.184 | 0.0369 | 27.1 |
| 13 | 0.01689 | 0.527 | 0.1013 | 0.1419 | 0.355 | 0.177 | 0.0355 | 28.2 |
| 14 | 0.01625 | 0.507 | 0.0975 | 0.1365 | 0.341 | 0.171 | 0.0341 | 29.3 |
| 15 | 0.01552 | 0.484 | 0.0931 | 0.1303 | 0.326 | 0.163 | 0.0326 | 30.7 |

TABLE 6
Processing Times for Curing Automobile Body Coatings with X-Rays
(Electron Energy 7 MeV, Beam Current 100 mA, Beam Power
700 kW, Dose 40 kGy, Width 2 m, Length 5 m)

| Steel | Energy | Ratio | Iron | Acrylate | Area | Line | Curing | Curing |
|---|---|---|---|---|---|---|---|---|
| Thickness | Deposition | Surface/ | Area K Factor | Area K Factor | Rate | Speed | Rate | Time |
| mm | MeV cm²/g | Depth | kGy m²/mA min | kGy m²/mA min | m²/min | m/min | car body/min | min/car body |
| 1 | 0.04182 | 1.000 | 0.2509 | 0.3513 | 0.878 | 0.439 | 0.0878 | 11.4 |
| 2 | 0.03868 | 0.925 | 0.2321 | 0.3249 | 0.812 | 0.406 | 0.0812 | 12.3 |
| 3 | 0.03715 | 0.889 | 0.2229 | 0.3121 | 0.780 | 0.390 | 0.0780 | 12.8 |
| 4 | 0.03507 | 0.839 | 0.2104 | 0.2946 | 0.737 | 0.368 | 0.0737 | 13.6 |
| 5 | 0.03299 | 0.789 | 0.1979 | 0.2771 | 0.693 | 0.346 | 0.0693 | 14.4 |
| 6 | 0.03122 | 0.746 | 0.1873 | 0.2622 | 0.656 | 0.328 | 0.0656 | 15.3 |
| 7 | 0.02961 | 0.708 | 0.1776 | 0.2487 | 0.622 | 0.311 | 0.0622 | 16.1 |
| 8 | 0.02870 | 0.686 | 0.1722 | 0.2411 | 0.603 | 0.301 | 0.0603 | 16.6 |
| 9 | 0.02714 | 0.649 | 0.1629 | 0.2280 | 0.570 | 0.285 | 0.0570 | 17.5 |
| 10 | 0.02577 | 0.616 | 0.1546 | 0.2165 | 0.541 | 0.271 | 0.0541 | 18.5 |
| 11 | 0.02498 | 0.597 | 0.1499 | 0.2098 | 0.524 | 0.262 | 0.0524 | 19.1 |
| 12 | 0.02429 | 0.581 | 0.1457 | 0.2040 | 0.510 | 0.255 | 0.0510 | 19.6 |
| 13 | 0.02289 | 0.547 | 0.1373 | 0.1923 | 0.481 | 0.240 | 0.0481 | 20.8 |
| 14 | 0.02223 | 0.532 | 0.1334 | 0.1867 | 0.467 | 0.233 | 0.0467 | 21.4 |
| 15 | 0.02161 | 0.517 | 0.1296 | 0.1815 | 0.454 | 0.227 | 0.0454 | 22.0 |
| 16 | 0.02012 | 0.481 | 0.1207 | 0.1690 | 0.423 | 0.211 | 0.0423 | 23.7 |

The values of the electron energy depositions within the target materials are about 100 times higher than the X-ray energy depositions in the external iron absorber. If the maximum electron energy depositions in the target were shown in these figures, the X-ray energy depositions in the iron absorber would hardly be noticeable.

Comparisons of the graphs in FIGS. 7, 8 and 10 and the data in tables 4, 5 and 6 show that the X-ray energy deposition per electron in the first zone of the external iron absorber increases with the electron energy incident on the X-ray target. The entrance values increase from 0.0218 at 5 MeV to 0.0320 at 6 MeV to 0.0418 a 7 MeV MeV. The increase from 5 to 7 MeV is a ratio of 1.92, which is nearly equal to the square of the ratio of the initial electron energies, (7/5)²=49/25=1.96. This result is consistent with the practical rule that the emitted X-ray power increases as the square of the electron energy times the electron beam current. If the beam current is held constant, then the X-ray emission increases as the square of the electron energy. On the other hand, if the beam power (energy times current) is held constant, so that if the beam current decreases as the electron energy increases, then the X-ray emission increases only as the first power of the electron energy.

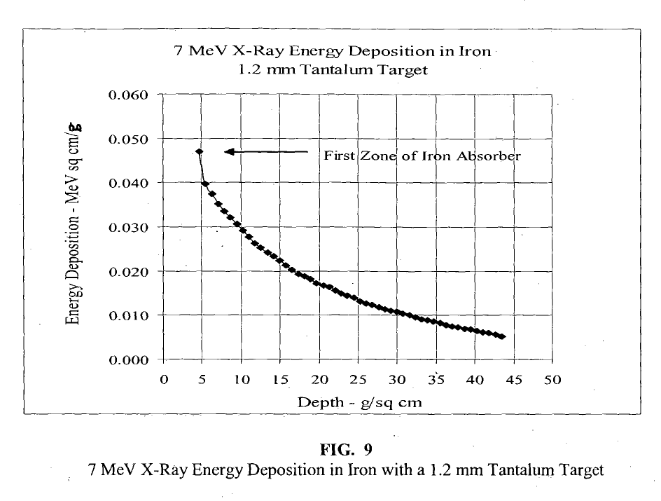

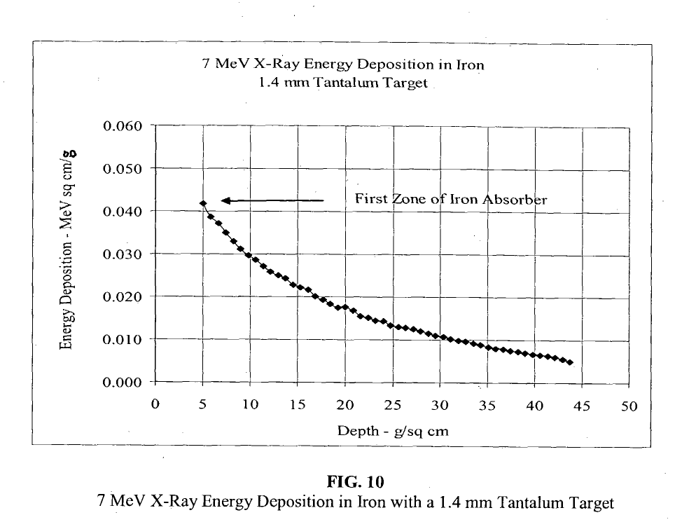

Comparing the graphs in FIGS. 9 and 10, it can be seen that the energy deposition per electron in the first zone of the external iron absorber is too high with the thinner tantalum target. In FIG. 9, the greater attenuation between the first and second iron zones shows that the additional energy deposition in the first iron zone is coming from low-energy electrons from the target, which are stopped in the first millimeter of the iron. This effect is not evident in FIG. 10 with the thicker tantalum target plate.

An organic coating on automobile parts will have a higher electron stopping power than that of an iron absorber. Therefore, the energy deposition in the coating, which will be exposed to the same secondary electron influence as the iron, will be higher than the energy deposition in the iron by the ratio of their electron stopping powers. The stopping power is defined as the energy in MeV deposited by an electron in passing through a zone of material with an area density 1 g/cm².

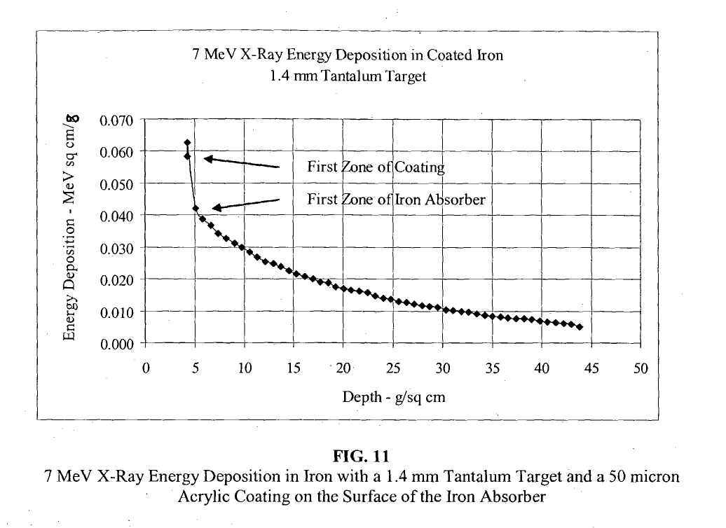

Once again, the coating is assumed to be an acrylated material with a stopping power similar to that of polymethyl methacrylate. The electron stopping power ratio is nearly independent of the electron energy, although the ratio decreases slightly as the electron energy increases. In the energy range from 0.2 to 0.5 MeV, which includes the most probable energies of the bremsstrahlung photons emitted by the target, the stopping power ratio is about 1.4. The higher energy deposition in the coating is confirmed by the data shown in FIG. 11, which was calculated with the assumption of a 50 micron acrylic coating on the iron absorber. The energy deposition in the first zone of the coating is 0.0585 and the energy deposition in the first zone of the iron is 0.0420. The ratio of these values is 1.39.

The attenuation curves in FIGS. 7, 8 and 10 show smooth transitions from the electron region to the X-ray region. This means that the dose at the surface of the external iron absorber is consistent with the exponential attenuation within this material. There is no surface-dose buildup effect, which occurs with collimated beams of high-energy photons.

The X-ray energy deposition values for iron, which were obtained from the Monte Carlo calculations with 5, 6 and 7 MeV electrons, are shown in the second column of Tables 4, 5 and 6 for depth increments of 1 mm in iron. The ratios of the depth values to the surface values are shown in the third column. The attenuation in the first millimeter of iron is about 7.5% for the 7 MeV data in Table 6. The half-value depth is nearly the same for the 5 and 6 MeV data in Tables 1 and 2, about 14 mm of iron. The half-value depth for the 7 MeV data is slightly greater, about 15.5 mm of iron.

The area throughput rates shown in the sixth column were calculated with the following equation:
A/T=KI/D
where the area throughput rate, A/T, is in units of sq m/min, I is the electron beam current in mA and D is the absorbed dose in kGy. No correction was made for any loss of beam current by over scanning the area of the product conveyor. The electron beam current was assumed to be 100 mA and the absorbed dose in the coating was assumed to be 40 kGy.

The factor, K, is the area processing coefficient in kGy sq m/mA min, which is equal to 6 times the energy deposition in MeV cm²/g. Values of K for iron are shown in the fourth column. The K factor for the coating, shown in the fifth column of the tables, has been obtained by multiplying the K factor for iron by 1.4, which is the appropriate value of the stopping power ratio of polymethyl methacrylate to iron. The area throughput rates in the sixth column are based on the higher K factors for an acrylic coating.

The line speed shown in the seventh column is the area throughput rate divided by the conveyor width, which is assumed to be 2 meters. The car body curing rate shown in the eighth column is the line speed divided by the conveyor length per car body, which is assumed to be 5 meters. The curing time per car body is the inverse of the car body curing rate.

The shortest curing time would be obtained with the highest X-ray energy. Based on the energy deposition at the surface of the coated iron, the curing time per car body would be about 11 minutes using 7 MeV X-rays with 100 mA of electron beam current on the target and an absorbed dose of 40 kGy in the coating. The curing times would be slightly longer if the dose were delivered through several millimeters of steel, as shown in the tables.

On the other hand, the curing times would be shorter if the required dose were lower, since the curing time is directly proportional to the dose. For example, if the dose could be reduced to 20 kGy instead of the assumed value of 40 kGy, the curing times listed in the tables would be cut in half. Also, if the car body were irradiated from opposite sides with two accelerators, the curing times could be nearly cut in half, and the uniformity of the dose distribution could be improved.

These Monte Carlo simulations show that organic coatings on complex steel structures, such as automobile bodies, can be cured by irradiation with high-energy X-rays. The main advantage of using this kind of energy is the relatively-low dose uniformity ratios that can be achieved with a simple product conveying system. The X-ray curing time per car body would be longer than the curing time by irradiation with high-energy electrons, assuming that the electron beam currents were the same, because of the relatively low efficiency for converting the incident electron beam power to emitted X-ray power.

### 6.3 Example 3

### Electron Beam Processing of Coated Plates and Plate Stacks

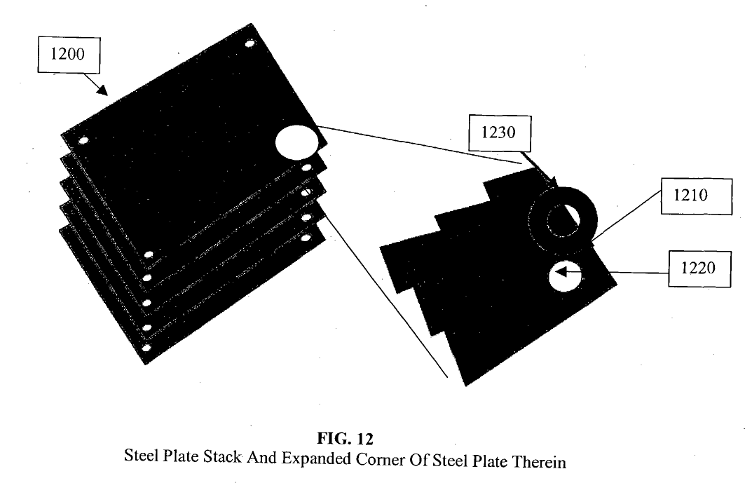

Fifteen steel plates (4″ by 12″), pretreated with conventional electrocoat and primer, were spray painted with an electron beam curable color (silver) basecoat. After the basecoat all fifteen of the painted plates were spray coated with a conventional clearcoat. Five of these plates were processed individually in a high energy electron beam irradiator (8 kW, 12 MeV) using standard tote trays at increments of 10 kGy up to 50 kGy. The remaining ten plates containing basecoat and primer were built into two stacks of five plates and processed at 30 kGy and 40 kGy. As illustrated in FIG. 12, each plate stack 1200 consisted of individual plates 1210 bolted to one another through corner holes 1220 and separated from one another by a spacer 1230 (0.25 inches thick). In addition, a single plate coated with electrocoat only and a single plate coated with electrocoat and primer only were processed increments of 10 kGy up to 50 kGy.

After each pass, the consistency of the coats was examined. The raw data for this experiment is set forth below:

TABLE 7

| Dose and Material | Time of Irradiation | Reaction of Basecoat | Reaction of Clearcoat |
|---|---|---|---|
| 10 kGy silver plate | 13:58 | Tacky, will wipe off | Still wet, wipes off |
| 10 kGy primed plate | 13:58 | No noticeable change | N/A |
| 10 kGy E coated plate | 13:58 | No noticeable change | N/A |
| 20 kGy silver plate | 14:14 | Can not wipe off paint | Still wet, wipes off |
| 20 kGy primed plate | 14:14 | No noticeable change | N/A |
| 20 kGy E coated plate | 14:14 | No noticeable change | N/A |
| 30 kGy silver plate | 14:21 | Can not wipe off paint | Still wet, wipes off |
| 30 kGy primed plate | 14:21 | No noticeable change | N/A |
| 30 kGy E coated plate | 14:21 | No noticeable change | N/A |
| 30 kGy silver stack | 14:21 | All plates cured | Still wet, wipes off |
| 40 kGy silver plate | 14:30 | Can not wipe off paint | Still wet, wipes off |
| 40 kGy primed plate | 14:30 | No noticeable change | N/A |
| 40 kGy E coated plate | 14:30 | No noticeable change | N/A |
| 40 kGy silver stack | 14:30 | All plates cured | Still wet, wipes off |
| 50 kGy silver plate | 14:38 | Can not wipe off paint | Still wet, wipes off |
| 50 kGy primed plate | 14:38 | No noticeable change | N/A |
| 50 kGy E coated plate | 14:38 | No noticeable change | N/A |

As set forth above, after the first pass at 10 kGy (13:58), all of the plates were still wet and both the basecoat and clear coat were easily wiped off. After the second pass at 20 kGy (14:14) the basecoat was dry but the clear coat was still wet. This remained the case after the third pass at 30 kGy (14:21), the fourth pass at 40 kGy (14:30), and the fifth pass at 50 kGy (14:38). There was no apparent change with any of the plates that were not coated with basecoat and clearcoat. There was no significant change in temperature—the 50 kGy plates were warm to the touch.

The stack of coated plates was treated in the third pass at 30 kGy (14:21) and the fourth pass at 40 kGy (14:30). All of the basecoats were cured.

Based on this experiment, it is evident that high energy electron beams can be used to penetrate multiple steel plates to cure electron beam curable basecoats. This penetration is the same penetration necessary to cure coatings in the shadows of automobile bodies. Accordingly, high energy electron beams can be used to penetrate the shadows of automotive bodies to cure electron beam curable basecoats. It should be noted that the basecoat and clearcoat can be simultaneously cured by employing an electron beam or X-ray curable basecoat in conjunction with an electron beam curable clearcoat.

7.0 Concluding Remarks

7.1 Incorporation By Reference

All publications, patents and patent applications mentioned in this specification are herein incorporated by reference to the same extent as if each individual publication, patent or patent application was specifically and individually indicated to be incorporated by reference. No admission is made that any reference cited herein is prior art.

7.2 Spirit of the Invention

The invention now having been fully described, it will be apparent to one of ordinary skill in the art that many changes and modifications can be made thereto without departing from the spirit or scope of the invention. Accordingly, the scope of the invention is determined by the claim limitations and any equivalents thereof as defined by law.

1. A method for curing one or more coatings on an automotive body comprising:
(i) coating the automotive body with at least one electron beam curable coating; and
(ii) moving the automotive body one or more times through one or more medium to high power, medium to high energy electron beams.

2. The method of claim 1 where the automotive body is moved one or more times through one or more high power high energy electron beams.

3. The method of claim 1 where the automotive body is moved by a continuous conveyor system into a vault that has a plurality of electron beam scanning units which deliver medium to high energy electron beams, generated by one or more accelerators, on opposite sides of the automotive body.

4. The method of claim 3 where the automotive body moves through the vault multiple times.

5. The method of claim 1 where a single electron beam accelerator and scanning unit is employed and a continuous conveyor tilts the automotive body to face the beam as it moves through a vault.

6. The method of claim 5 where the automotive body moves through the vault multiple times.

7. The method of claim 1 where the automotive body is coated with an electrocoat, a primer, a basecoat and a clear coat.

8. The method of claim 7 where the basecoat is an electron beam curable coating.

9. The method of claim 1 where the electron beam curable coating is an unsaturated oligomer or polymer.

10. The method of claim 9 where the electron beam curable coating is an acrylate functional oligomer or polymer.

11. A method for curing one or more coatings on an automotive body comprising:
(i) coating the automotive body with at least one X-ray curable coating; and
(ii) moving the automotive body one or more times through one or more X-ray fields generated by striking a metal target with a medium to high power, medium to high energy electron beam.

12. The method of claim 11 where the automotive body is moved one or more times through one or more X-ray fields generated by striking a metal target with a high power high energy electron beam.

13. The method of claim 11 where the automotive body is moved by a conveyor through a vault where the automotive body is immersed in a single X-ray field.

14. The method of claim 13 where the automotive body moves through the vault multiple times.

15. The method of claim 11 where the automotive body is moved by a conveyor through a vault where the automotive body is immersed in a plurality of X-ray fields.

16. The method of claim 15 where the automotive body passes through the vault multiple times.

17. The method of claim 11 where the automotive body is coated with an electrocoat, a primer, a basecoat and a clear coat.

18. The method of claim 17 where the basecoat is an X-ray curable coating.

19. The method of claim 11 where the X-ray curable coating is an unsaturated oligomer or polymer.

20. The method of claim 19 where the X-ray curable coating is an acrylate functional oligomer or polymer.

21. A method for curing one or more coatings on an object made from a sheet material that is curved, bent or folded into a three dimensional structure comprising: (i) coating the object with at least one electron or X-ray curable coating; and (ii) moving the object one or more times through one or more medium to high power, medium to high energy electron beams or X-ray fields, where at least one electron beam and/or X-ray field is capable of penetrating through multiple layers of said sheet material to cure areas of coating outside the line of sight of said beam or field.

22. The method of claim 21 where the sheet material has an equivalent area density of at least 0.4 mm of steel.

23. The method of claim 22 where the sheet material is steel sheet.

24. A facility that comprises the following components: (i) one or more objects made from a sheet material that is curved, bent or folded into a three dimensional structure and coated with one or more electron beam or X-ray curable coatings; (ii) a conveyor system for moving said one or more objects past an electron beam and/or X-ray field; and (iii) one or more accelerators capable of generating one or more medium to high power, medium to high energy electron beams and/or X-ray fields capable of penetrating through multiple layers of said sheet material to cure areas of coating not in the line of sight of said beam(s) and/or field(s).

25. The facility of claim 24 where the sheet material has an equivalent area density of at least 0.4 mm of steel.

26. The facility of claim 25 where the sheet material is steel sheet.
